(19) United States
(12) Patent Application Publication
(10) Pub. No.: US 2007/0170709 A1
(43) Pub. Date: Jul. 26, 2007

(54) Air bag module with vent flow control

(75) Inventors: William P. Braun, Romeo, MI (US); Ken Taggart, ST. Clair Shores, MI (US); Douglas M. Gould, Lake Orion, MI (US); Kurt F. Fischer, Leonard, MI (US); Alex G. Meduvsky, Romeo, MI (US); Michael J. Loyd, Rochester Hills, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/336,072

(22) Filed: Jan. 20, 2006

(51) Int. Cl. B60R 21/26; B60R 21/23; B60R 21/205

(52) U.S. Cl. 280/739; 280/743.2; 280/728.2; 280/732; 280/742

(57) ABSTRACT

An apparatus (10) for helping to protect an occupant of a vehicle includes a housing (20) including a vent opening (70). An air bag (14) is inflatable to deploy away from the housing (20). An inflation fluid source (26) provides inflation fluid for inflating the air bag (14). A vent member (80) has a closed condition blocking inflation fluid flow through the vent opening (70) and an open condition permitting inflation fluid flow through the vent opening. A first tether (114) is configured to release the vent member (80) for movement from the closed condition when the air bag (14) has deployed a first distance away from the housing (20). A second tether (140) is configured to place the vent member (80) in the closed condition when the air bag (14) has deployed a second distance away from the housing (20), the second distance being farther away from the housing than the first distance.

### TECHNICAL FIELD

The present invention relates to an apparatus for controlling flow of inflation fluid through a vent opening of an air bag module. More specifically, the present invention relates to an apparatus for opening and closing a vent member to control inflation fluid flow through the vent opening.

### BACKGROUND OF THE INVENTION

It is known to provide a vent opening in a housing of an air bag module to allow for venting inflation fluid away from an air bag. A vent member may be associated with the vent opening and operable to open or close the vent opening. The position of the vent member may be dependent upon a position of an occupant of a seat associated with the air bag module. For example, in some air bag modules, an actuator that moves the vent member is controlled in response to signals from an occupant position sensor.

In other air bag modules, a tether extends between a panel of the air bag and the vent member. When the panel of the air bag moves relative to the air bag module housing beyond a predetermined distance, the tether pulls the vent member to move the vent member relative to the housing.

### SUMMARY OF THE INVENTION

The present invention relates to an apparatus for helping to protect an occupant of a vehicle. The apparatus includes a housing including a vent opening. An air bag is inflatable to deploy away from the housing. An inflation fluid source provides inflation fluid for inflating the air bag. A vent member has a closed condition blocking inflation fluid flow through the vent opening and an open condition permitting inflation fluid flow through the vent opening. A first tether is configured to release the vent member for movement from the closed condition when the air bag has deployed a first distance away from the housing. A second tether is configured to place the vent member in the closed condition when the air bag has deployed a second distance away from the housing, the second distance being farther away from the housing than the first distance.

The present invention also relates to an apparatus for controlling flow of inflation fluid through a vent opening in an air bag module. The apparatus includes a vent member having a closed condition blocking inflation fluid flow through the vent opening and an open condition permitting inflation fluid flow through the vent opening. The apparatus also includes a latch that maintains the vent member in the closed condition. A first tether is configured to actuate the latch to release the vent member from the closed condition when the air bag reaches a predetermined first position during inflation. A second tether associated with the vent member is configured to place the vent member in the closed condition when the air bag reaches a predetermined second position during inflation.

The present invention further relates to an apparatus for helping to protect an occupant of a vehicle. The apparatus includes a housing including a vent opening and an air bag inflatable to deploy away from the housing. An inflation fluid source provides inflation fluid for inflating the air bag. A vent member has a closed condition blocking inflation fluid flow through the vent opening. The vent member is configured for pivotal movement from the closed condition to an open condition permitting inflation fluid flow through the vent opening upon inflation of the air bag. At least one stop piece limits pivotal movement of the vent member to a predetermined position. A tether is configured to move the vent member toward the closed condition when the air bag has deployed a predetermined distance away from the housing. The predetermined position to which the stop piece limits pivotal movement of the vent member being selected so that tension forces exerted on the vent member by the tether are sufficient to cause the vent member to pivot toward the closed condition.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a perspective view of an apparatus for helping to protect a vehicle occupant, according to the present invention;

FIG. 2 is a sectional view of the apparatus taken generally along line 2-2 in FIG. 1;

FIG. 3 is an enlarged view of a portion of the apparatus of FIG. 2; and

FIGS. 4A-4C are schematic sectional views illustrating the operation of the apparatus.

### DETAILED DESCRIPTION OF THE INVENTION

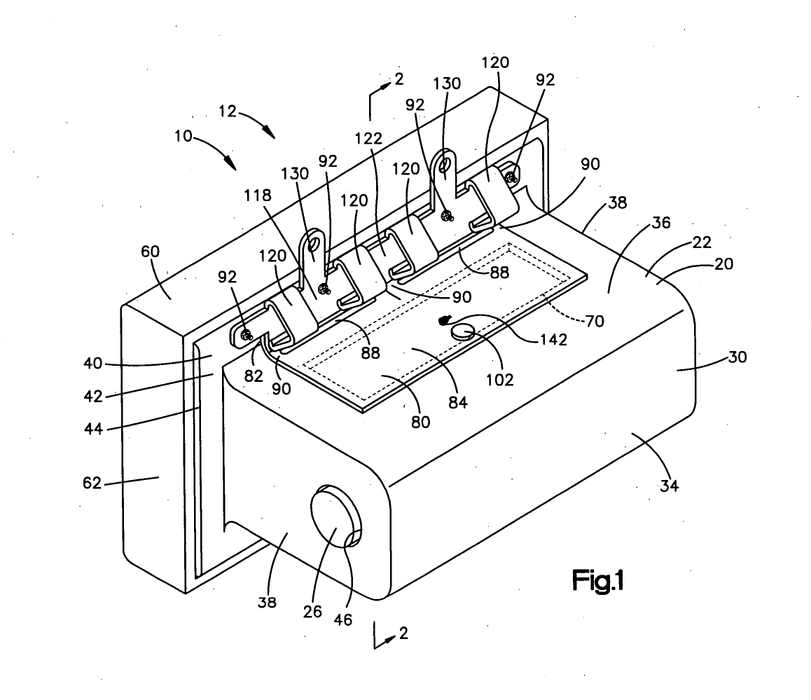

The present invention relates to an apparatus for helping to protect an occupant of a vehicle. Referring to FIG. 1, the vehicle occupant protection apparatus 10 comprises an air bag module 12. The air bag module 12 of FIG. 1 is a front seat passenger air bag module configured to be mounted in an instrument panel on a passenger side of a vehicle (not shown in FIG. 1). Alternatively, the apparatus 10 could be a driver air bag module (not shown) configured to be mounted, for example, in a steering wheel of the vehicle.

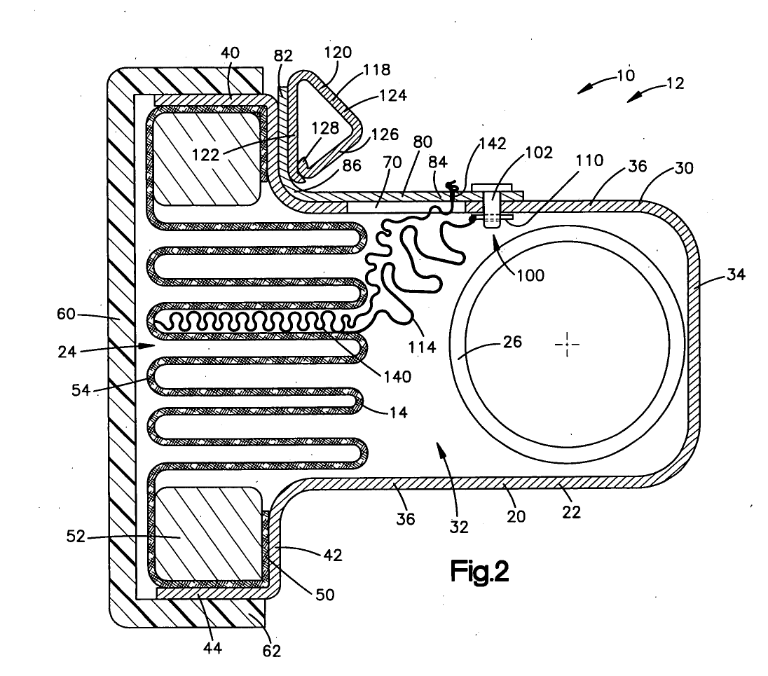

Referring to FIGS. 1 and 2, the air bag module 12 includes an air bag 14. In a stored condition, the air bag 14 is folded, rolled, or otherwise packaged and placed in a housing 20. In the illustrated embodiment, the housing 20 comprises a reaction canister 22 configured to be mounted in the instrument panel of the vehicle. The reaction canister 22 includes a deployment opening 24 through which the air bag 14 is deployed during inflation.

The air bag module 12 also includes an inflation fluid source in the form of an inflator 26 that is actuatable to provide inflation fluid for inflating the air bag 14. The inflator 26 is located in the reaction canister 22 and supported by the reaction canister. The inflator 26 may be of any suitable construction or configuration. For example, the inflator 26 may contain a stored quantity of pressurized inflation fluid (not shown) in the form of a gas for inflating the air bag 14. As another example, the inflator 26 could contain a combination of pressurized inflation fluid and ignitable material for heating the inflation fluid, or could be a pyrotechnic inflator that uses the combustion of gas-generating material to generate inflation fluid. As a further example, the inflator 26 could be of any suitable type or construction for supplying a medium for providing inflation fluid for inflating the air bag 14.

The air bag module 12 also includes a cover 60 for covering the deployment opening 24 of the reaction canister 22. As shown schematically in FIG. 2, the cover 60 has a peripheral portion 62 that cooperates with the reaction canister 22 in a known manner to secure the cover to the canister. The cover 60 is placed in an open condition by forces exerted by the inflating air bag 14. This enables the air bag 14 to exit the reaction canister 22 and deploy through the deployment opening 24. For example, the cover 60 may include a tear seam (not shown) that ruptures to place the cover in the open condition. As another example, the cover 60 may be adapted to release from the reaction canister 22 and pivot or otherwise move away from the deployment opening 24 to place the cover in the open condition.

The reaction canister 22 has a main body portion 30 that includes a rear wall 34, first and second side walls 36, and first and second end walls 38. The reaction canister 22 also includes a retainer portion 40 that extends from an open end of the main body portion 30. The retainer portion 40 includes a flange portion 42 that extends transversely outward (e.g., about perpendicularly) from terminal ends of the side walls 36 and end walls 38 opposite the rear wall 34. The retainer portion 40 also includes a peripheral rim portion 44 that extends from ends of the flange portion 42 opposite the main body portion 30.

The flange portion 42 and rim portion 44 of the retainer portion 40 help define the deployment opening 24. The main body portion 30 and retainer portion 40 help define a chamber 32 of the reaction canister 22 in which the inflator 26 is supported. As shown in FIG. 1, the end walls 38 may include means 46, such as a surface that defines an opening in an end wall, for helping to support the inflator 26. As shown in FIG. 2, the chamber 32 also receives the air bag 14 when deflated and folded in the stored condition.

A mouth portion 50 (FIG. 2) of the air bag 14 is secured to the retainer portion 40 of the reaction canister 22 by a retainer 52. The retainer 52 is configured for being seated in and connected to the retainer portion 40 in a known manner, such as via threaded fasteners or a snap fit connection. In the assembled condition of FIG. 2, the mouth portion 50 is clamped between the retainer portion 40 and retainer 52, thus connecting the air bag 14 to the reaction canister 22.

The mouth portion 50 defines an inflation fluid opening in the air bag 14 for receiving inflation fluid from the inflator 26 via the deployment opening 24. Opposite the mouth portion 50, the air bag 14 includes an outer portion or panel 54 that is presented toward a vehicle occupant (not shown) when the air bag is inflated. In the stored condition, the air bag 14 is folded so that the outer panel 54 is located proximate the reaction canister 22 (see, e.g., FIG. 2). During inflation of the air bag 14, the outer panel 54 moves away from the reaction canister 22 as described below.

The reaction canister 22 also includes a vent opening 70. In the embodiment illustrated in FIGS. 1 and 2, the vent opening 70 is located in the upper side wall 36 of the main body portion 30. The vent opening 70 could have a variety of alternative configurations. For example, the vent opening 70 may comprise multiple openings and may be located in other walls of the reaction canister, such as the opposite (lower) side wall 36, the end walls 38, or the rear wall 34. The vent opening 70 provides fluid communication between the chamber 32 and the exterior of the reaction canister 22.

The air bag module 12 also includes a vent member 80 for selectively blocking fluid flow through the vent opening 70. The vent member 80 comprises a base portion 82 and a cover portion 84 separated by a hinge portion 86. A pair of elongated slots 88 extend through the vent member 80 and help define three hinge members 90 of the hinge portion 86. The base portion 82 and cover portion 84 each have a generally planar configuration and are oriented perpendicular to each other. The base portion 82 is secured to the reaction canister 22 by means 92, such as threaded fasteners. The fasteners may also secure the retainer 52 (FIG. 2) to the reaction canister 22.

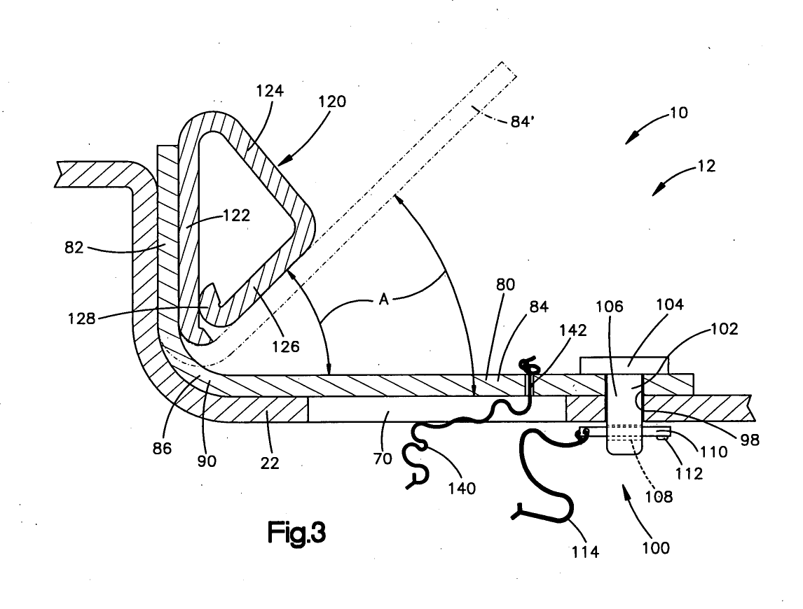

The cover portion 84 of the vent member 80 has dimensions greater than the dimensions of the vent opening 70 and thus covers the vent opening as shown in FIG. 1. Referring to FIG. 3, an opening 98 extends through the cover portion 84 and a corresponding portion of the upper side wall 36 of the reaction canister 22. The opening 98 is spaced from the hinge portion 86 and located centrally along the cover portion 84.

Referring to FIGS. 2 and 3, the air bag module 12 also includes a vent latch mechanism 100. The latch mechanism 100 includes a member 102, such as a stud, that has a head portion 104 secured to the cover portion 84 and a shank portion 106 that extends through the opening 98 into the chamber 32 of the housing 20. An aperture 108 extends through the shank portion 106 transverse to the length of the shank portion. A locking pin 110 extends through aperture 108 and includes means 112, such as a spring loaded ball bearing or a clip, that helps keep the locking pin in the aperture. A first tether 114 has a first end connected to the outer panel 54 of the air bag 14 and an opposite second end connected to the locking pin 110. The first tether 114 may have any construction or configuration suited to perform the functions described herein. For example, the first tether 114 may comprise a length of fabric having a first end portion sewn to the outer panel 54 and an opposite second end portion looped through an aperture in the locking pin 110 and knotted.

The stud 102 and locking pin 110 cooperate to provide a releasable connection for securing the vent member 80 in the closed position of FIG. 2. Those skilled in the art will appreciate that the stud/locking pin mechanism of the illustrated embodiment could be replaced with an alternative mechanism suited to provide a releasable connection for securing the vent member 80 in the closed position.

Referring to FIG. 3, the cover portion 84 of the vent member 80 is movable or pivotable about the hinge portion 86 from the closed condition illustrated at 84 to an open position illustrated in dashed lines at 84′. As shown in FIGS. 1 and 3, the air bag module 12 also includes a stop bracket 118 that includes stop pieces 120 for limiting pivotal movement of the cover portion 84. The stop bracket 118 has a base portion 122 secured to the reaction canister 22 by means, such as threaded fasteners. For example, as shown in FIG. 1, the threaded fasteners 92 that secure the vent member 80 to the reaction canister 22 may also secure the stop bracket 118 to the reaction canister. Alternatively, the stop pieces 120 could be formed as integral portions of the vent member 80.

Each stop piece 120 includes a first leg 124 that extends at an angle from the base portion 122 of the vent member 80 and a second leg 126 that extends at an angle from the first leg. The stop pieces 120 terminate with a curved portion 128 positioned adjacent or engaging the base portion 122. As shown in FIG. 1, the stop bracket 118 may also include mounting tabs 130 that may be used to help secure the air bag module 12 in the vehicle.

The vent member 80 is constructed and arranged so that when the cover portion 84 pivots about the hinge portion 86, it engages the stop pieces 120. The stop pieces 120 prevent further pivotal movement of the cover portion 84. The cover portion 84, when in the open position illustrated at 84′, rests against the second legs 126 of the stop pieces 120. The stop pieces 120 are constructed and arranged such that the second legs 126 extend at a predetermined angle relative to the side wall 36 of the reaction canister 22. The predetermined angle is illustrated generally at “A” in FIG. 3 and may, for example, be about 42-45 degrees. The stop pieces 120 therefore limit the angle of the cover member 84 relative to the side wall 36 to the predetermined angle A.

The air bag module 12 also includes a second tether 140 associated with the vent member 80. The second tether 140 has a first end connected to the outer panel 54 of the air bag 14 and an opposite second end connected to the cover portion 84. In the illustrated embodiment, the connection between the second tether 140 and the cover portion 84 is facilitated by an aperture 142 in the cover portion through which the second tether extends. For example, the second tether 140 may extend through the aperture 142 and be knotted or otherwise tied to the cover portion 84. The second tether 140 may have any construction or configuration suited to perform the functions described herein. For example, the second tether 140 may comprise a length of fabric sewn to the outer panel 54 and looped through the aperture 142.

Upon the occurrence of an event for which inflation of the air bag 14 is desired, such as a vehicle impact or rollover, the inflator 26 is actuated in a known manner to direct inflation fluid into the air bag 14. In response to receiving inflation fluid, the air bag 14 inflates and deploys through the deployment opening 24 in the reaction canister 22 away from the instrument panel.

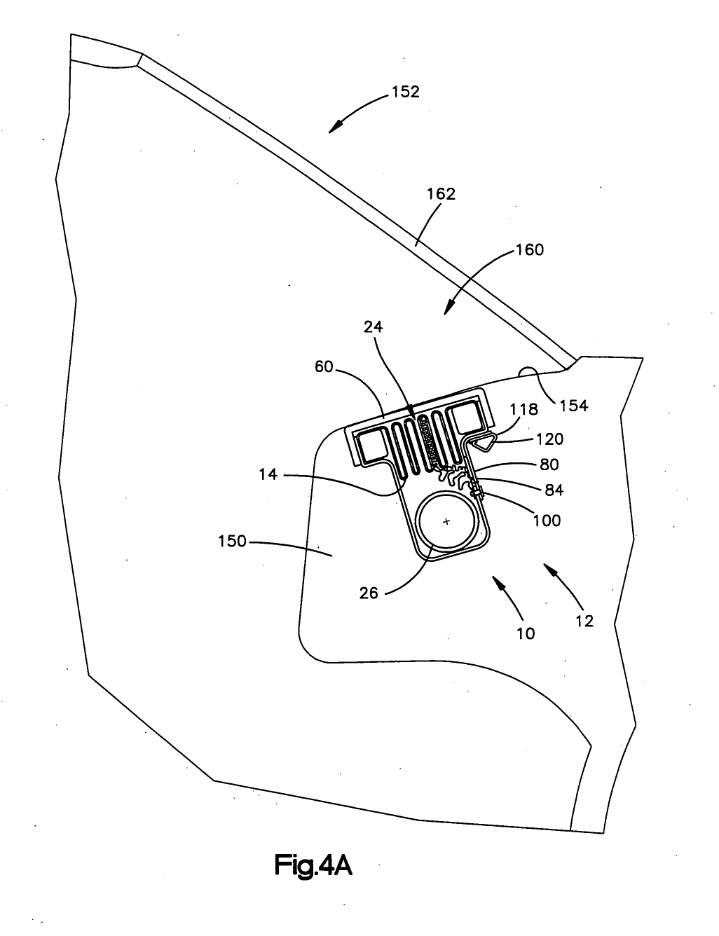

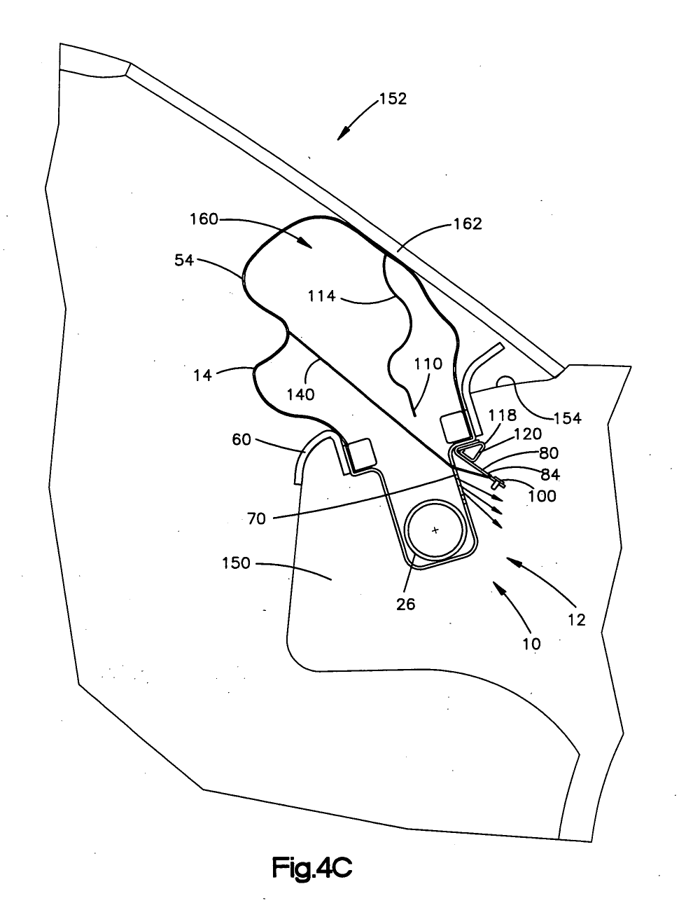

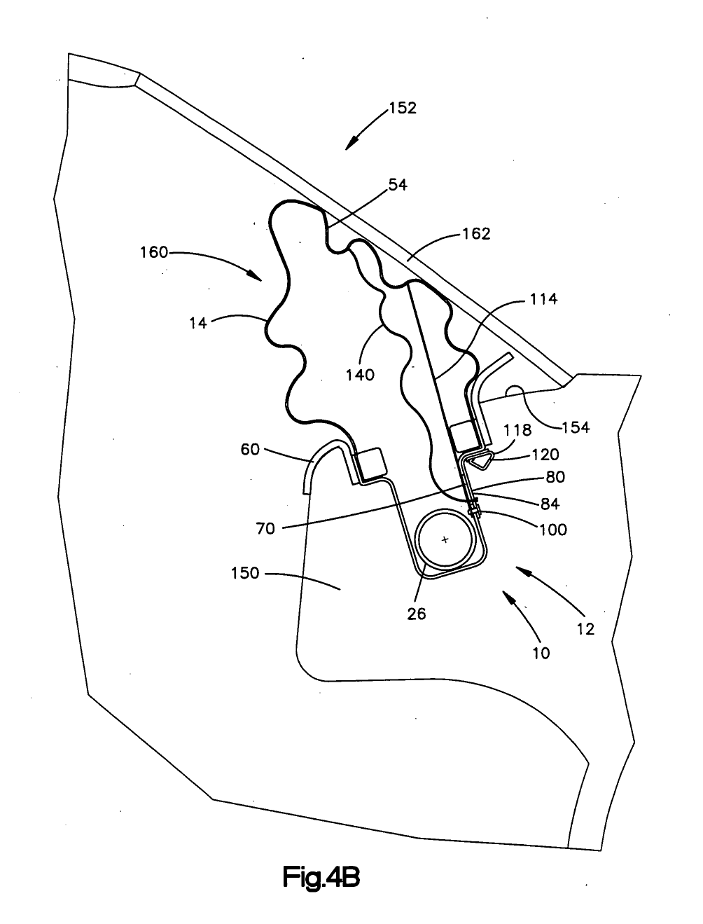

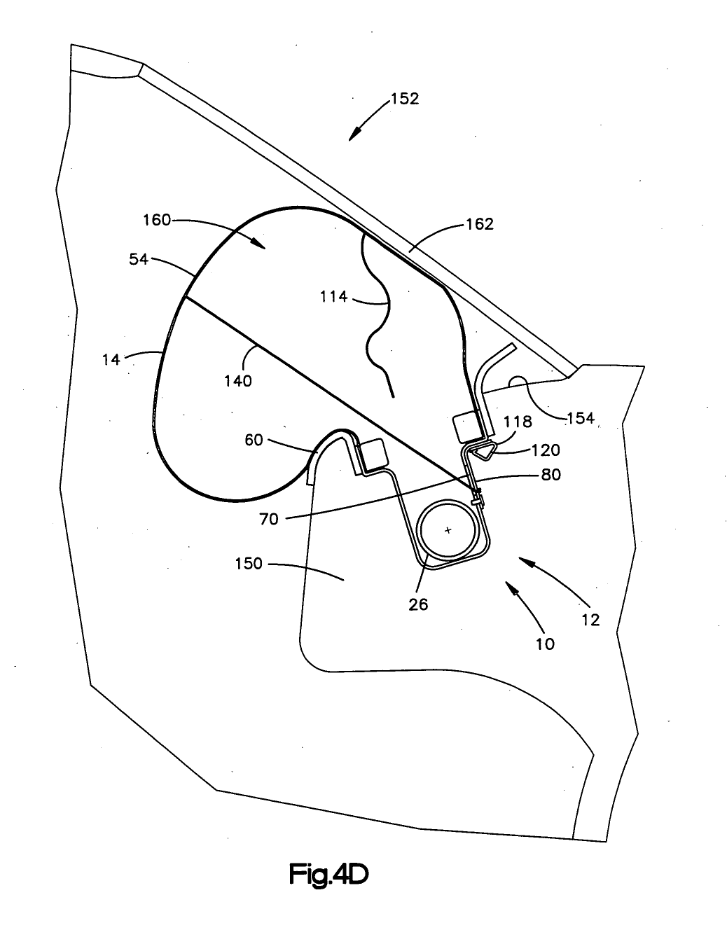

As the air bag 14 inflates and deploys, the first tether 114, second tether 140, and latch mechanism 100 help control the operation of the vent member 80. This is illustrated in FIGS. 4A-4D. In FIGS. 4A-4D, the air bag module 12 is illustrated installed in an instrument panel 150 of a vehicle 152 in what is referred to as a top-mount installation. By “top-mount,” it is meant that the air bag module 12 is installed in the instrument panel 150 with the discharge opening 24 presented facing in a generally upward direction in the vehicle 152 from a top or upper surface 154 of the instrument panel. In the stored condition of FIG. 4A, the cover 60 may thus be flush with the upper surface 154 and may form or otherwise define a portion of the upper surface. The air bag module 12 could, however, be configured for alternative installations. For example, the air bag module 12 could be configured for a mid-mount installation in which the module is installed in the instrument panel with the discharge opening 24 presented facing generally rearward in the vehicle toward the occupant compartment.

As the inflator 26 discharges inflation fluid into the air bag 14, the cover 60 opens (FIG. 4B) and the air bag begins to inflate and deploy in a generally upward direction into a space 160 defined between the instrument panel 150 and a windshield 162 of the vehicle 152. During this time, the latch mechanism 100 maintains the vent member 80 in the closed condition blocking inflation fluid flow out of the vent opening 70. Since the space 160 may comprise a relatively large volume, it may be advantageous to block fluid flow from the vent opening 70 during this initial phase of air bag inflation and deployment.

When the outer panel 54 of the air bag 14 reaches a first predetermined position, the first tether 114 is drawn taut. This is shown in FIG. 4B. The first predetermined position is defined, at least partially, by the length of the first tether 114. For example, the length of the first tether 114 may be selected such that the first tether is drawn taut as the outer panel 54 of the air bag 14 moves near or engages the windshield 162. As another example, the length of the first tether 114 may be selected such that the first tether is drawn taut as the air bag 14 inflates to fill, substantially fill, or fill a predetermined portion of the space 160. At this point, the second tether 140 remains with slack, as shown in FIG. 4B.

As the air bag 14 continues to inflate and deploy beyond the position of FIG. 4B, the first tether 114 pulls the pin 110 from the stud 102 and the latch mechanism 100 releases the vent member 80. This is shown in FIG. 4C. When the latch member 100 releases the vent member 80, the vent member moves to the open condition and inflation fluid is permitted to flow through the vent opening 70, as indicated by the arrows in FIG. 4C. This may, for example, help reduce or lessen the force and speed with which the air bag 14 deploys. Thus, in effect, the first tether 114 and latch mechanism 100 cooperate to block venting through the vent opening 70 while the air bag 14 deploys a first distance or to a first extent, and permit venting once the air bag 14 deploys beyond the first distance or the first extent.

The stop pieces 120 limit movement of the cover portion 84 to the position shown in FIG. 4C. The curved portion 128 of the stop pieces 120 act as a guide or form around which the vent member 80, particularly the hinge members 90, deflect when moved to the open condition. This helps avoid over-bending of the vent member 80, bending the vent member at an undesirable angle, or otherwise placing the vent member at a position or angle that is undesirable in terms of providing complete vent closure or consistent vent opening/closing times. Configuring the vent member 80 to deflect around and rest against the stop pieces 120 in this manner helps provide a uniform opening time and open position for the vent member 80. This also helps provide a uniform closing time for the vent member 80 and a more consistent closing force required to move the vent member to the closed condition.

As the air bag 14 continues to inflate and deploy, the air bag engages the windshield 162 and is deflected or otherwise directed to deploy rearward in the vehicle 152 away from the windshield. The length of the first tether 114 may be selected such that the latch mechanism 100 releases the vent member 80 as this rearward deployment of the air bag 14 begins.

The vent member 80 may be configured to move to the open condition when released by the latch mechanism 100 in a variety of manners. For example, referring to FIG. 2, the vent member 80 may have a metal (e.g., stamped sheet metal) construction in which the hinge portion 86 and, particularly, the hinge members 90 (see FIG. 1) are configured to deform under the pressure of inflation fluid in the chamber 32. The vent member 80 would thus be placed in the open condition by fluid pressure in the chamber 32. As another example, the vent member 80 may have a plastic (e.g., injection molded plastic) construction in which cover portion 84 is biased to the open condition relative to the base portion 82. In this configuration, when the latch mechanism 100 is released, the cover portion 84 would move to the open condition under its own inherent bias and under the force of inflation fluid pressure in the chamber 32. As a further example, the cover portion 84 and base portion 82 of the vent member 80 may be separate parts connected by a mechanical hinge (not shown) that may or may not be biased toward the open condition by means, such as a spring. In this instance, the vent member 80 may be placed in the open condition by fluid pressure, spring bias, or both.

When the outer panel 54 of the air bag 14 reaches a second predetermined position, the second tether 140 is drawn taut. This is shown in FIG. 4C. The second predetermined position is defined, at least partially, by the length of the second tether 140. For example, the length of the second tether 140 may be selected such that the second tether is drawn taut as the outer panel 54 of the air bag 14 approaches a fully inflated and deployed position after being deflected by the windshield 162.

As the air bag 14 continues to inflate and deploy beyond the position of FIG. 4C, the second tether 140 exerts a force on the cover portion 84 of the vent member 80. The force with which the second tether 140 pulls on the cover portion 84 overcomes the bias or deformation of the cover portion and the inflation fluid forces acting on the cover portion. The vent member 80 is thus placed in the closed condition in response to the tension applied via the second tether 140. This is shown in FIG. 4D. When the air bag 14 reaches the inflated and deployed condition, therefore, the vent member 80 is in the closed condition and inflation fluid flow through the vent opening 70 is blocked. The air bag 14 may thus provide a desired ride down effect.

Advantageously, the stop pieces 120 maintain the cover portion 84 of the vent member 80 at an angle that facilitates closing the vent member when the second tether 140 is tensioned. Because the cover portion 84 is maintained at this angle, the second tether 140 extends at an angle relative to the cover portion. The second tether 140, when tensioned, exerts a force on the cover portion 84, a component of which urges the cover portion to move or bend at the hinge portion 86 toward the closed position. If the position of the cover portion 84 was not maintained by the stop piece 120, the angle between the cover portion and the second tether 140 would be reduced or eliminated. As a result, the force exerted on the cover portion 84 by the second tether 140 might be insufficient to place the vent member 80 in the closed condition.

Those skilled in the art will appreciate that the second tether 140 may not function to close the vent member 80 if deployment of the outer panel 54 of the air bag 14 is impeded. This might happen, for example, if the inflating air bag 14 contacts an object, such as an occupant (not shown), positioned relatively close to the instrument panel 150. If this occurs, the second tether 140 remains slacked and the vent member 80 remains in the open condition. This provides for venting inflation fluid through the vent opening 70, which helps reduce the force and pressure with which the air bag 14 inflates and deploys.

From the above description of the invention, those skilled in the art will perceive improvements, changes, and modifications. Such improvements, changes, and modifications within the skill of the art are intended to be covered by the appended claims.

Having described the invention, the following is claimed:

1. An apparatus for helping to protect an occupant of a vehicle, the apparatus comprising:
a housing including a vent opening;
an air bag inflatable to deploy away from the housing;
an inflation fluid source for providing inflation fluid for inflating the air bag;
a vent member having a closed condition blocking inflation fluid flow through the vent opening and an open condition permitting inflation fluid flow through the vent opening;
a first tether configured to release the vent member for movement from the closed condition when the air bag has deployed a first distance away from the housing; and
a second tether configured to place the vent member in the closed condition when the air bag has deployed a second distance away from the housing, the second distance being farther away from the housing than the first distance.

2. The apparatus recited in claim 1, further comprising means for maintaining the vent member in the closed condition, the first tether being configured to actuate the means for maintaining the vent member in the closed condition to release the vent member when the air bag has deployed the first distance away from the housing.

3. The apparatus recited in claim 2, wherein the means for maintaining the vent member in the closed condition comprises a release pin for locking the vent member in the closed condition, the first tether having a first end portion connected to the release pin and an opposite second end portion connected to the air bag.

4. The apparatus recited in claim 1, wherein the first tether has a length selected to release the vent member from the closed condition when the air bag engages a windshield of the vehicle.

5. The apparatus recited in claim 4, wherein the second tether has a length selected to place the vent member in the closed condition after the windshield directs the air bag toward the deployed condition.

6. The apparatus recited in claim 1, wherein the apparatus comprises a top-mount front seat passenger air bag module adapted to deploy the air bag initially toward a windshield of the vehicle, the windshield directing the air bag to deploy toward a deployed position between an occupant and an instrument panel of the vehicle.

7. The apparatus recited in claim 6, wherein the first tether is configured to release the vent member from the closed condition when the inflating air bag occupies a predetermined space between the instrument panel and the windshield.

8. The apparatus recited in claim 7, wherein the second tether is configured to place the vent member in the closed condition when the inflating air bag has deployed a predetermined distance away from the windshield.

9. The apparatus recited in claim 1, wherein the first tether has a first end connected to the air bag and an opposite second end associated with the vent member, the first tether having a first length selected such that the inflating air bag tensions the first tether when the panel has moved a predetermined distance away from the housing.

10. The apparatus recited in claim 9, wherein the second tether has a first end connected to the air bag and an opposite second end connected to the vent member, the second tether having a second length selected such that the inflating air bag places the vent member in the closed condition when the panel has moved a predetermined distance away from the housing.

11. The apparatus recited in claim 10, wherein the second length is greater than the first length.

12. The apparatus recited in claim 1, wherein the vent member is initially in a closed condition prior to inflation of the air bag and during initial inflation of the air bag.

13. The apparatus recited in claim 1, further comprising a stop piece against which the vent member rests in the open condition, the stop piece limiting travel of the vent member to a predetermined position.

14. The apparatus recited in claim 13, wherein the predetermined position to which vent member travel is limited is selected so that the second tether extends at an angle with the vent member so that tension on the second tether results in component forces sufficient to cause the vent member to move toward the closed condition.

15. The apparatus recited in claim 13, wherein the vent member is configured for pivoting movement from the closed condition to the open condition, the predetermined position to which vent member travel is limited is selected so that tension forces exerted on the vent member by the second tether are sufficient to cause the vent member to pivot toward the closed condition.

16. An apparatus for controlling flow of inflation fluid through a vent opening in an air bag module, the apparatus comprising:
a vent member having a closed condition blocking inflation fluid flow through the vent opening and an open condition permitting inflation fluid flow through the vent opening;
a latch that maintains the vent member in the closed condition;
a first tether associated with the latch, the first tether being configured to actuate the latch to release the vent member from the closed condition when the air bag reaches a predetermined first position during inflation; and
a second tether associated with the vent member, the second tether being configured to place the vent member in the closed condition when the air bag reaches a predetermined second position during inflation.

17. An apparatus for helping to protect an occupant of a vehicle, the apparatus comprising:
a housing including a vent opening;
an air bag inflatable to deploy away from the housing;
an inflation fluid source for providing inflation fluid for inflating the air bag;
a vent member having a closed condition blocking inflation fluid flow through the vent opening, the vent member being configured for pivotal movement from the closed condition to an open condition permitting inflation fluid flow through the vent opening upon inflation of the air bag;
at least one stop piece for limiting pivotal movement of the vent member to a predetermined position; and
a tether configured to place the vent member in the closed condition when the air bag has deployed a predetermined distance away from the housing, the predetermined position to which the at least one stop piece limits pivotal movement of the vent member being selected so that tension forces exerted on the vent member by the tether are sufficient to cause the vent member to pivot toward the closed condition.
